(19) United States
(12) Patent Application Publication
(10) Pub. No.: US 2016/0023380 A1
(43) Pub. Date: Jan. 28, 2016

(54) IMPRINT METHOD, IMPRINT APPARATUS, AND ARTICLE MANUFACTURING METHOD

(71) Applicant: CANON KABUSHIKI KAISHA, Tokyo (JP)

(72) Inventor: Yousuke Kondo, Utsunomiya-shi (JP)

(21) Appl. No.: 14/803,163

(22) Filed: Jul. 20, 2015

(30) Foreign Application Priority Data
Jul. 22, 2014 (JP) 2014-148752

(51) Int. Cl. B29C 37/00; B29C 43/02; B29C 43/58; B29C 59/02

(52) U.S. Cl. CPC B29C 37/0067; B29C 59/022; B29C 59/026; B29C 43/021; B29C 43/58; B29K 2105/0005

(57) ABSTRACT

Provided is an imprint method comprising a step for determining whether or not a process for reducing adhesive strength between the imprint material and the pattern of the mold is required, wherein, if the determination step determines that the process for reducing adhesive strength is required, the process for reducing adhesive strength is performed by bringing the material for reducing adhesive strength on the substrate for reducing adhesive strength, which is different from a substrate to be patterned, into contact with the pattern of the mold, and then an imprint process is performed, whereas if the determination step determines that the process for reducing adhesive strength is not required, the process for reducing adhesive strength is not performed, and the imprint process is performed.

### BACKGROUND OF THE INVENTION

1. Field of the Invention

The present invention relates to an imprint method, an imprint apparatus, and an article manufacturing method.

2. Description of the Related Art

The imprint technology, which allows a nanoscale fine pattern to be transferred, has begun to be utilized as one of the nanolithography technologies for mass-producing magnetic storage media, semiconductor devices, or the like. In the imprint method, a fine pattern is formed on a substrate such as a silicon wafer, glass plate, or the like using a mold on which the fine pattern has been formed with an apparatus such as an electron beam lithography apparatus or the like. This fine pattern is formed by applying a resin on the substrate and then curing the resin with the mold having the pattern formed thereon being pressed on the substrate through the resin.

One important characteristic for accurately forming a pattern on a substrate to be processed by the imprint method is releasability (mold releasability) when a mold having a pattern formed thereon is released from a resin, for example. One factor having an influence on the releasability is, for example, the adhesive strength between a mold and a resin material or transfer layer on a substrate. In order to improve the releasability, the adhesive strength needs to be reduced. Japanese Unexamined Patent Application Publication (Translation of PCT Application) No. 2006-528088 discloses a method for improving the releasability by including a material for reducing adhesive strength, which has a higher affinity to a mold than a resin, into the resin that is applied on a substrate, and then pressing the mold and the resin against each other to bring the material for reducing adhesive strength into contact with the mold. Japanese Unexamined Patent Application Publication (Translation of PCT Application) No. 2006-528088 also describes a method for undercoating a material for reducing adhesive strength on a mold by bringing an undercoated substrate, on which the material for reducing adhesive strength is undercoated, into contact with the pattern of the mold repeatedly.

However, Japanese Unexamined Patent Application Publication (Translation of PCT Application) No. 2006-528088 has no specific description for the imprint method including a process for reducing adhesive strength when the undercoated substrate is used and an imprint process on the substrate to be processed, that is, regarding a step for determining whether or not a process for reducing adhesive strength on a mold is required after pressing a pattern on the substrate to be processed, or the like. In order to improve the releasability without reducing the productivity due to using the undercoated substrate, the efficiency of the work needs to be improved by performing the step for determining whether or not the process for reducing adhesive strength is required.

### SUMMARY OF THE INVENTION

The present invention provides, for example, an imprint method for improving the releasability without reducing the productivity.

According to an aspect of the present invention, an imprint method for performing an imprint process in which an imprint material on a substrate to be patterned is brought into contact with a pattern of a mold to form a pattern of the imprint material, the imprint method comprising a step of determining whether or not a process for reducing adhesive strength for reducing adhesive strength between the imprint material and the pattern of the mold is required, wherein, if the determination step determines that the process for reducing adhesive strength is required, the process for reducing adhesive strength is performed by bringing a material for reducing adhesive strength on a substrate for reducing adhesive strength, which is different from the substrate to be patterned, into contact with the pattern of the mold, and then an imprint process is performed, and wherein if the determination step determines that the process for reducing adhesive strength is not required, the process for reducing adhesive strength is not performed and an imprint process is performed.

Further features of the present invention will become apparent from the following description of exemplary embodiments (with reference to the attached drawings).

### BRIEF DESCRIPTION OF THE DRAWINGS

FIG. 1A is a schematic diagram illustrating a configuration of an imprint apparatus according to a first embodiment of the present invention.

FIG. 1B is an enlarged view illustrating the transfer mechanism of the imprint apparatus shown in FIG. 1A.

FIGS. 2A to 2F illustrate an imprint method according to a first embodiment.

FIG. 3 is a schematic diagram illustrating a configuration of a mask according to a first embodiment.

FIGS. 4A and 4B illustrate a state in which a particle exists between a mask and a substrate.

FIG. 5 is a schematic diagram illustrating a configuration of a substrate conveyance mechanism according to a first embodiment.

FIG. 6 is a flowchart of a process including a process for reducing adhesive strength according to a first embodiment.

FIG. 7 illustrates the information about a transfer area according to a first embodiment.

FIG. 8 is a schematic diagram illustrating a configuration of a substrate conveyance mechanism according to a second embodiment.

FIG. 9 is a flowchart of a process including a process for reducing adhesive strength according to a second embodiment.

FIG. 10 is a schematic diagram illustrating a configuration of a substrate conveyance mechanism according to a third embodiment.

FIG. 11 is a flowchart of a process including a process for reducing adhesive strength according to a third embodiment.

### DESCRIPTION OF THE EMBODIMENTS

Hereinafter, preferred embodiments of the present invention will be described with reference to the attached drawings.

### First Embodiment

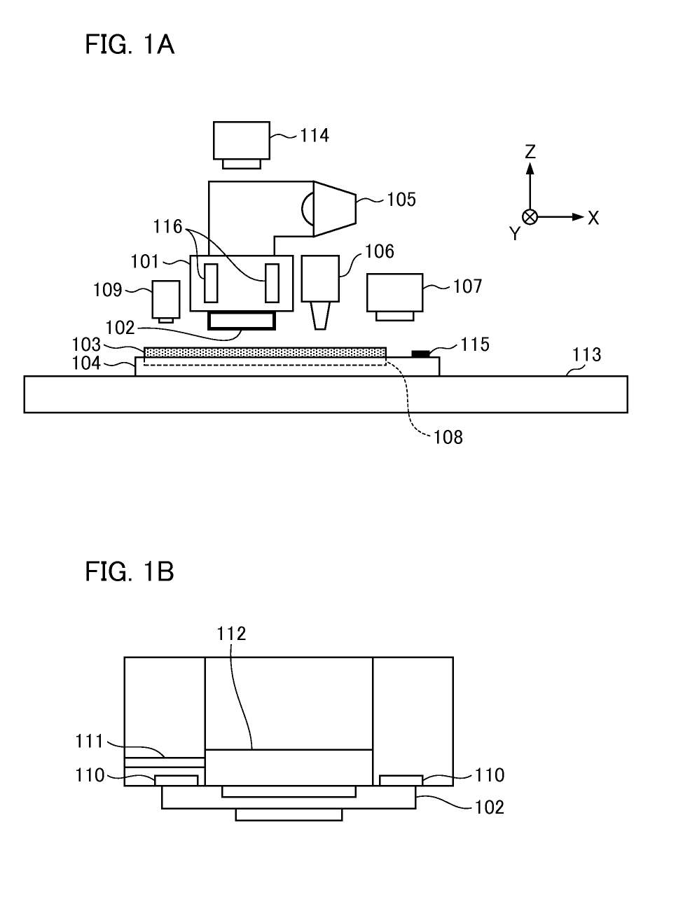

Firstly, a configuration of an imprint apparatus according to a first embodiment of the present invention will be described. FIG. 1A is a schematic diagram illustrating a configuration of the imprint apparatus (transfer system) according to a first embodiment of the present invention. The imprint apparatus includes a transfer mechanism 101, a substrate stage 104, a light source system 105, an applying mechanism 106, an off-axis alignment scope 107, substrate holding mechanisms 108 and 113, a filling camera 114, a substrate-stage-side mark 115, and a control unit (not shown). The imprint apparatus holds a substrate 103 on the substrate holding mechanism 108 of the substrate stage 104. A mark (not shown) formed on the substrate and the substrate-stage-side mark 115 are detected by the off-axis alignment scope 107 so as to calculate an amount of position/shape misalignment between the substrate stage 104 and the substrate 103. A mask-side mark 306 and the substrate-stage-side mark 115 are detected by an on-axis alignment scope 116 so as to calculate an amount of position/shape misalignment between the substrate stage 104 and a mask (mold) 102. A position/shape correction mechanism (not shown) corrects the amount of position/shape misalignment. The applying mechanism 106 performs applying of a photocurable resin 201 (imprint material) on each shot region.

The substrate holding mechanism 108 includes a substrate suction mechanism and a substrate holding chuck. The substrate holding chuck is composed of one or more region(s), and each region is provided with the substrate suction mechanism. The filling camera 114 can take a photograph of a first pattern portion 301 from the side of a mask holding mechanism 110, and can record the process in which the photocurable resin 201 is filled between the mask 102 and the substrate 103. The images recorded by the filling camera 114 are stored on a memory device (not shown). The relative positions between the mask-side mark 306 and the mark formed on the substrate 103 and between the mask-side mark 306 and the substrate-stage-side mark 115 are measured with an optical position detector as disclosed in Japanese unexamined patent application publication (Translation of PCT Application) No. 2008-509825, for example. In particular, the measurement using the Moire signals that are generated from the both sides are useful because a high measuring precision can be obtained with a simple optical system. Furthermore, since the Moire signals described above can be detected without a high precision optical system, a scope having a small resolving power (small NA) can be employed, and a plurality of scopes can be arranged. This allows, for example, a configuration by which the marks on the four corners of a shot can be measured at the same time.

As shown in FIG. 1B, the transfer mechanism 101 includes the mask 102, the mask holding mechanism 110, a mask-back-side pressure control mechanism 111, and a seal glass 112. The transfer mechanism 101 holds the mask 102 by suctioning the mask 102 by the mask holding mechanism 110, and drives it in the Z axis direction so as to bring the shot region(s) on the substrate 103 into contact with the pattern of the mask 102. The mask-back-side pressure control mechanism 111 can increase or reduce the atmospheric pressure in the mask-back-side space surrounded by the seal glass 112 and the back side of the mask. The mask-back-side pressure control mechanism 111 can locally increase the atmospheric pressure in the mask-back-side space so as to be higher than that in the imprint apparatus, thereby deforming the concave portion in the mask 102 into a convex shape in a direction opposite to the transfer mechanism 101.

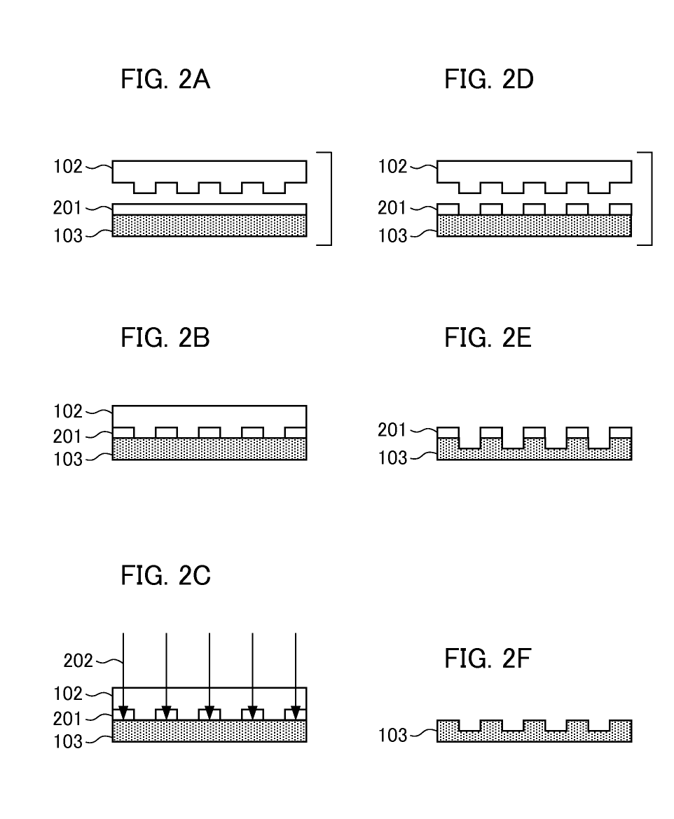

Next, an imprint method for performing an imprint process in which an imprint material on a substrate is brought into contact with a pattern of a mold to form a pattern of the imprint material will be described with reference to FIGS. 2A to 2F. Firstly, as shown in FIG. 2A, the photocurable resin 201 is applied by the applying mechanism 106 onto the substrate 103 so as to form a specified applying pattern. Next, as shown in FIG. 2B, the mask 102 is moved close to the photocurable resin 201 and the substrate 103 to bring the mask 102 into contact with the photocurable resin 201 so as to fill the photocurable resin 201 into the mask 102. Next, as shown in FIG. 2C, the photocurable resin 201 is cured with an exposure light 202 irradiated from the light source system 105. After the photocurable resin 201 has been cured, the mask 102 is released from the photocurable resin 201 and the substrate 103. As shown in FIG. 2D, when the mask 102 is released, a mask pattern that has been transferred to the photocurable resin 201 appears. The process shown in FIGS. 2A to 2D is performed with the imprint apparatus. Then, as shown in FIG. 2E, an etching process is performed using the photocurable resin 201 as the mask, and as shown in FIG. 2F, when the photocurable resin 201 is removed, a pattern has been transferred to the substrate 103. The process shown in FIG. 2E is performed with an etching apparatus, while the process shown in FIG. 2F is performed with a photocurable resin stripping apparatus. The main conditions for transferring a pattern include a filling time, an exposure time, and/or an applying pattern of the curable resin.

The imprint method according to the present embodiment further includes a process for reducing adhesive strength between an imprint material and a pattern of a mold in addition to the above-described imprint method. The specific process will be described below. Here, a substrate for reducing adhesive strength used in the process for reducing adhesive strength will be described. The releasability can be improved by exposing the mask 102 to an adjustment mixture containing an additive agent for reducing surface energy (material for reducing adhesive strength). The releasability can also be improved by bringing the photocurable resin 201 including the adjustment mixture containing an additive agent for reducing surface energy into contact with the mask 102. The substrate for reducing adhesive strength may be made of silicon, plastic, gallium arsenide, mercury telluride, or even a complex material thereof. The substrate for reducing adhesive strength is shaped so as to be mountable on the substrate stage 104 in a manner similar to the substrate 103 (substrate to be patterned) that is a common substrate for production. The adjustment mixture, which contains an additive agent for reducing surface energy, or the photocurable resin 201, which includes the adjustment mixture containing an additive agent for reducing surface energy, may be spin-coated on the surface of the substrate in advance for reducing adhesive strength. The releasability can be improved using the substrate for reducing adhesive strength precoated with the photocurable resin 201 including the adjustment mixture containing more additive agent for reducing surface energy more than in the substrate for production without changing the characteristic of the photocurable resin 201 for production.

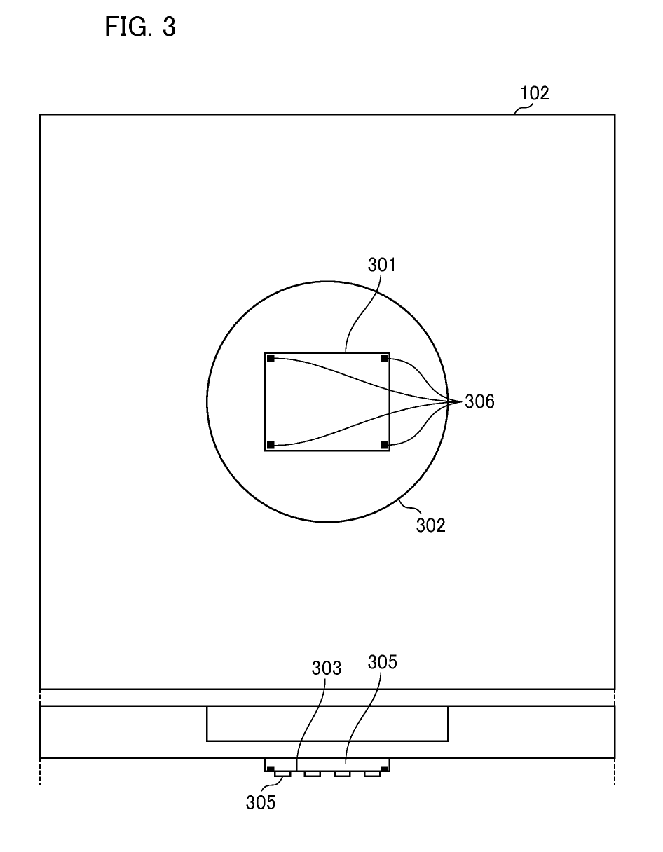

The mask 102 may be made of any material including, but not limited to, fused silica, an organic polymer, or a metal. As shown in FIG. 3, the mask 102 has a concave portion 302 that is formed by cutting into the center part. The thickness of the concave portion 302 is suitably about 1 mm. One side of the mask without the concave portion 302 is regarded as a first surface, while the other side of the mask with the concave portion 302 is regarded as a second surface. The first pattern portion 301 is formed at the center of the concave region on the first surface. The first pattern portion 301 is composed of a first pattern base 305 and a pattern, in which the first pattern base 305 is configured to have a thickness of about 30 μm. When a pattern used for production is formed on the first pattern portion 301, a pattern of, for example, several nanometers or several tens of nanometers can be formed for a fine pattern. In this case, a pattern depth from a first pattern convex portion 304 to a concave portion 303 is about several tens or several hundreds of nanometers. The first pattern base 305 also includes the mask-side mark 306 used by the on-axis alignment scope 116. In the present invention, the mask 102 that is used includes a flat pattern having no difference in depth from the first pattern convex portion 304 to the concave portion 303.

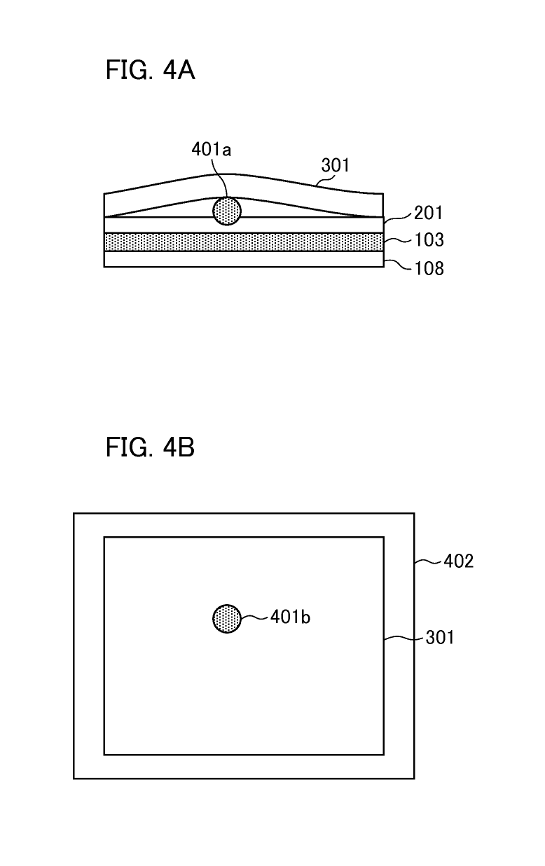

FIGS. 4A and 4B illustrate how the filling camera 114 observes a particle when it is present between the first pattern portion 301 of the mask and the substrate 103 during imprinting. FIG. 4A illustrates the relationship between (the first pattern portion 301) of the mask 102, the substrate 103, and a particle 401a. In the case where the particle 401a is present between the substrate 103 and the mask 102 as illustrated, the thickness of the photocurable resin 201 is about 50 μm, the size of the particle 401a is several micrometers to several tens of micrometers or less, and each thickness of the substrate 103 and the first pattern portion 301 of the mask 102 is 700 to 1000 μm. The refractive indexes of the mask 102 and the photocurable resin 201 are so close to each other that they cannot be detected by the filling camera 114 at the imaging wavelength of the filling camera 114. FIG. 4B illustrates an observed image 402 taken by the filling camera 114 after the photocurable resin 201 has been filled into the circuit pattern and before the mask 102 is released from the photocurable resin 201. The presence of the particle 401a prevents the photocurable resin 201 from being filled into the circuit and accordingly causes the first pattern portion 301 of the photocurable resin 201 to have nonuniformity in a film thickness, and a void. Therefore, in the filling camera image before releasing the mask, an observed particle 401b corresponding to the particle 401a is observed.

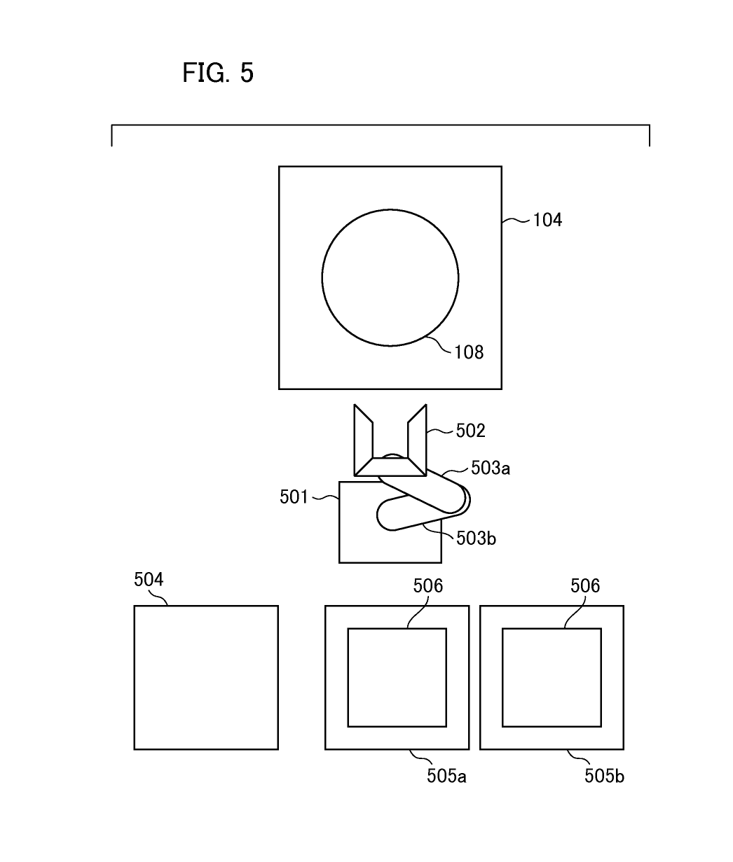

FIG. 5 is a schematic diagram illustrating a configuration of a substrate conveyance mechanism according to the present embodiment. The substrate conveyance mechanism includes a substrate conveyance unit 501, a substrate storage device 504, a first substrate conveying-in/out mechanism 505a, a second substrate conveying-in/out mechanism 505b, and a substrate carrier 506. The substrate conveyance unit 501 is composed of a first substrate conveyance arm 503a and a second substrate conveyance arm 503b that can be driven in the vertical direction, rotated and extended in the horizontal direction, and of a substrate conveyance hand 502 that can be rotated in the horizontal direction. The substrate conveyance hand 502, which includes a suction mechanism on the top surface, can suction the substrate 103. The substrate storage device 504, which includes one or more slot(s), can store one or more substrate(s) 103. The substrate carrier 506 that holds several pieces of substrate 103 is conveyed into/out of the first substrate conveying-in/out mechanism 505a and the second substrate conveying-in/out mechanism 505b. The substrate conveyance hand 502 can convey the substrates 103 one by one into/out of the substrate stage 104, any slot of the substrate storage device 504, and any slot of the substrate carrier 506 attached to the first substrate conveying-in/out mechanism 505a or the second substrate conveying-in/out mechanism 505b. In the present embodiment, the substrate for reducing adhesive strength is stored in the substrate storage device 504. In order to store the substrate for reducing adhesive strength in the substrate storage device 504, the substrate carrier 506 that holds the substrate for reducing adhesive strength is conveyed into the first substrate conveying-in/out mechanism 505a or the second substrate conveying-in/out mechanism 505b. Then, the substrate conveyance hand 502 conveys the substrate for reducing adhesive strength into an empty slot of the substrate storage device 504. When several pieces of substrates for reducing adhesive strength are stored in the substrate storage device 504, the substrate conveyance hand 502 conveys the substrates for reducing adhesive strength into empty slots of the substrate storage device 504 several times one by one. When the used substrate for reducing adhesive strength is conveyed outside the apparatus, the substrate carrier 506 having an empty slot is conveyed into the first substrate conveying-in/out mechanism 505a or the second substrate conveying-in/out mechanism 505b. Then, the substrate conveyance hand 502 conveys-out the used substrate for reducing adhesive strength to an empty slot of the substrate carrier 506. When several pieces of substrates for reducing adhesive strength are conveyed-out to the substrate carrier 506, the substrate conveyance hand 502 conveys the substrates for reducing adhesive strength into empty slots of the substrate carrier 506 several times one by one. As described above, the substrate(s) for reducing adhesive strength is(are) conveyed through a path different from a conveyance path for the substrate for production.

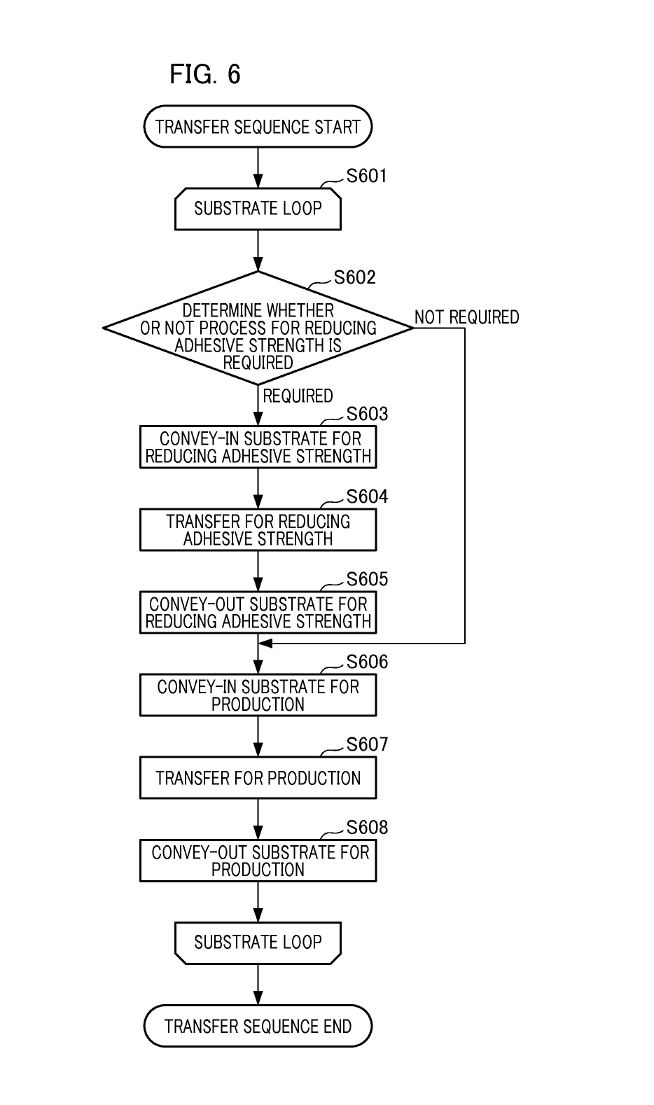

Here, a transfer sequence (imprint method) including a process for reducing adhesive strength according to the present embodiment will be described with reference to FIG. 6. In the transfer sequence, the control unit of the imprint apparatus performs “transfer for production” (step 5607) by performing the imprint method as described above with reference to FIGS. 2A to 2F on the substrate 103 (substrate to be patterned) that has been conveyed to the substrate stage 104. Every time the substrate 103 is conveyed, “substrate loop” (step S601) is performed for production. In the step S601, “determination of necessity of process for reducing adhesive strength” (step S602) is performed for determining whether or not “transfer for reducing adhesive strength” (step S604) is required in order to reduce the adhesive strength between the photocurable resin 201 of the substrate 103 and the pattern of the mask 102. In the step S602, the upper limit of the number of times that the mask 102 is transferred to the substrate 103 (predetermined number of transfer) is determined in advance, and when the time exceeds the upper limit, it is determined that the step S604 is required. The above-described criterion for the step S602 is only one example and does not limit the use of other criteria. For example, the other criteria for the step S602 include whether or not the total time of filling exceeds the predetermined time when the transfer of the mask 102 to the substrate 103 is performed several times. Furthermore, whether or not the number of the contaminating particle 401b that is observed by the filling camera 114 exceeds the predetermined number may be used as the criterion.

For the step S604, transfer conditions such as a number of transfer shots, a size of transfer shots, a filling time, an exposure time, or an applying pattern of the curable resin are specified independently of the conditions for the step S607. However, the transfer sequence is the same as the one for the step S607. Note that when the photocurable resin 201 including the adjustment mixture containing an additive agent for reducing surface energy is spin-coated on the substrate for reducing adhesive strength in advance, the photocurable resin 201 is not applied by the applying mechanism 106. A number of transfer shots, a filling time, an exposure time, or an applying pattern of the curable resin is specified as the recipe for reducing adhesive strength.

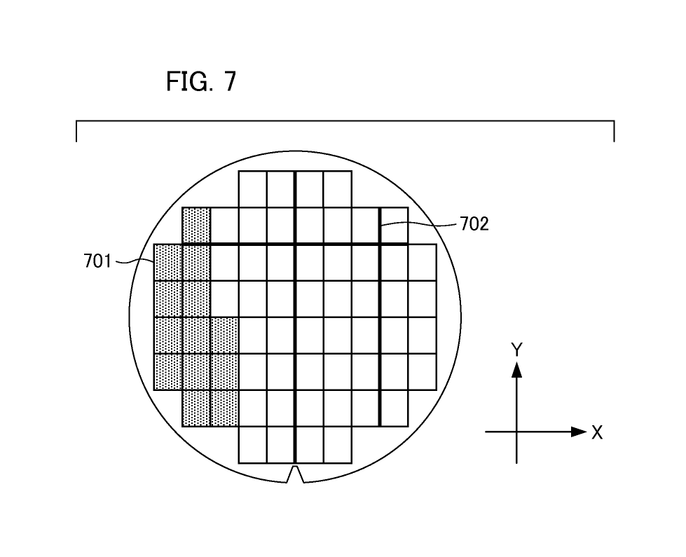

In the step S602, when it is determined that the step S604 is not required, the step S604 is not performed and the process proceeds to “conveying-in substrate for production” (step S606). In contrast, when it is determined that the step S604 is required, “conveying-in substrate for reducing adhesive strength” (step S603) is performed. In the step S603, when the substrate for reducing adhesive strength is not mounted on the substrate holding mechanism 108, the substrate conveyance unit 501 conveys the substrate for reducing adhesive strength that is stored in the substrate storage device 504 into the substrate holding mechanism 108. In the step S604, the process is performed on one or more shot(s) in the substrate for reducing adhesive strength by bringing the pattern of the mask 102 into contact with the photocurable resin 201 including the adjustment mixture containing an additive agent. Then, “conveying-out substrate for reducing adhesive strength” (step S605) is performed. In the step S605, the substrate conveyance unit 501 conveys-out the substrate to the substrate storage device 504. The information about the transfer area on which the step S604 has been performed is recorded for each substrate for reducing adhesive strength. For example, as shown in FIG. 7, the shot center (X,Y) of each of used shots 701 as well as the X size and Y size of the shot are recorded as the information about the transfer area. The information about the transfer area is kept until the substrate for reducing the adhesive strength has been conveyed outside the apparatus. Furthermore, the information about the transfer area is reported to a system external to the apparatus such that the system external to the apparatus can perform an replacement schedule for the substrate for reducing adhesive strength. A shot position(s) that can be used in the substrate for reducing adhesive strength is(are) determined from the used shots 701 in the information about the transfer area, the number of transfer shots specified in the recipe for reducing adhesive strength, and the X size and Y size of the transfer shots. Then, reserved shots 702 to be used in the step S604 is determined. When several pieces of substrate for reducing adhesive strength having the reserved shots 702 of the number of shots to be used in the step S604 are present in the substrate storage device 504, the substrate for reducing adhesive strength is used preferentially in the older order conveyed to the substrate storage device 504. The method for choosing the substrate 103 among a plurality of usable substrates for reducing adhesive strength as described above is only one example and does not limit the use of other criteria. For example, the substrate 103 in the upper slot of the substrate storage device 504 may be preferentially used. Assume that no substrate for reducing adhesive strength having the reserved shots 702 of the number of shots to be used in the step S604 are present in the substrate storage device 504. In this case, if the number of shots to be used in the step S604 is satisfied by conveying several pieces of substrate stored in the substrate storage device 504, the substrates for reducing adhesive strength are conveyed into the substrate holding mechanism 108 one by one, and the step S604 is performed. This is repeated until the required number of shots is satisfied. If the number of shots to be used in the step S604 is not satisfied by conveying the several pieces of substrate stored in the substrate storage device 504, the system external to the apparatus is requested to replace this with substrates for reducing adhesive strength.

In the step S606, the substrate conveyance unit 501 conveys-out the substrate 103 (substrate to be patterned) in the substrate holding mechanism 108 to the substrate storage device 504 or the substrate carrier 506. Then, the substrate conveyance unit 501 conveys-in the substrate 103 in the substrate carrier 506 to the substrate holding mechanism 108. In the step S607, the process is performed under the condition(s) specified in the recipe for production by the imprint method as described with reference to FIGS. 2A to 2F. In “conveying-out substrate for production” (step S608), the substrate conveyance unit 501 conveys-out the substrate 103 in the substrate holding mechanism 108 to the substrate carrier 506.

As described above, according to the present embodiment, the imprint method that can improve the releasability without reducing the productivity can be provided. Note that although the step S602 is performed every time after the step S608 in the transfer sequence, it may be performed in the step S607, in which the substrate for production is replaced with the substrate for reducing adhesive strength once, and then the step S604 may be performed.

### Second Embodiment

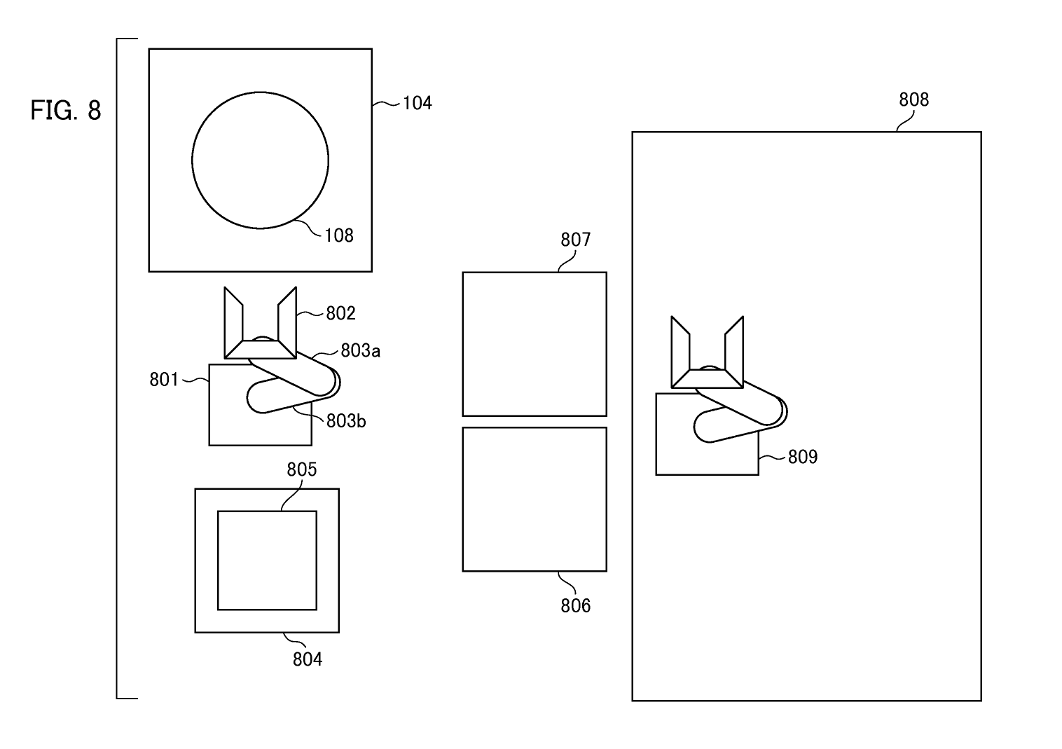

Next, an imprint method according to a second embodiment of the present invention will be described. A difference between the first embodiment and the present embodiment is how to convey a substrate. FIG. 8 is a schematic diagram illustrating a configuration of a substrate conveyance mechanism according to the present embodiment. The substrate conveyance mechanism according to the present embodiment employs a substrate supply system 808 instead of the substrate storage device 504 according to the first embodiment. Note that in the present embodiment, the same components as those in the first embodiment are designated by the same reference numerals and the detailed explanation thereof will be omitted. Additionally, since the configurations of the transfer system and transfer mechanism of the present embodiment are basically similar to those of the first embodiment, the detailed explanation thereof except for the parts regarding the substrate conveyance mechanism will be omitted.

A substrate conveyance unit 801 is composed of a first substrate conveyance arm 803a and a second substrate conveyance arm 803b that can be driven in the vertical direction, rotated and extended in the horizontal direction, and of a substrate conveyance hand 802 that can be rotated in the horizontal direction. The substrate conveyance hand 802, which includes a suction mechanism on the top surface, can suction the substrate 103. A substrate carrier 805 that holds several pieces of substrates 103 is conveyed into/out of a substrate conveying-in/out mechanism 804. A substrate conveying-in entrance 806 is a substrate holding mechanism that conveys-in a piece of substrate 103 from the substrate supply system 808 adjacent thereto. A substrate conveying-out exit 807 is a substrate holding mechanism that conveys-out a piece of substrate 103 to the substrate supply system 808 adjacent thereto. The substrate conveyance hand 802 can convey the substrates 103 one by one into/out of the substrate stage 104, the substrate conveying-in/out mechanism 804, the substrate conveying-in entrance 806, and the substrate conveying-out exit 807.

The substrate supply system 808 has a mechanism (not shown) for holding several pieces of substrates 103 and a mechanism (not shown) for spin-coating the photocurable resin 201 including the adjustment mixture containing an additive agent for reducing surface energy on the substrate for reducing adhesive strength. The substrate supply system 808 can convey the substrates for reducing adhesive strength or the substrates 103 (substrate to be patterned) one by one into/out of the substrate conveying-in entrance 806 or the substrate conveying-out exit 807 by the substrate conveyance unit 801. In the present embodiment, the substrate for reducing adhesive strength is supplied through the substrate conveying-in entrance 806. Thus, the substrate for reducing adhesive strength is conveyed through a path different from a conveyance path for the substrate for production (substrate to be patterned).

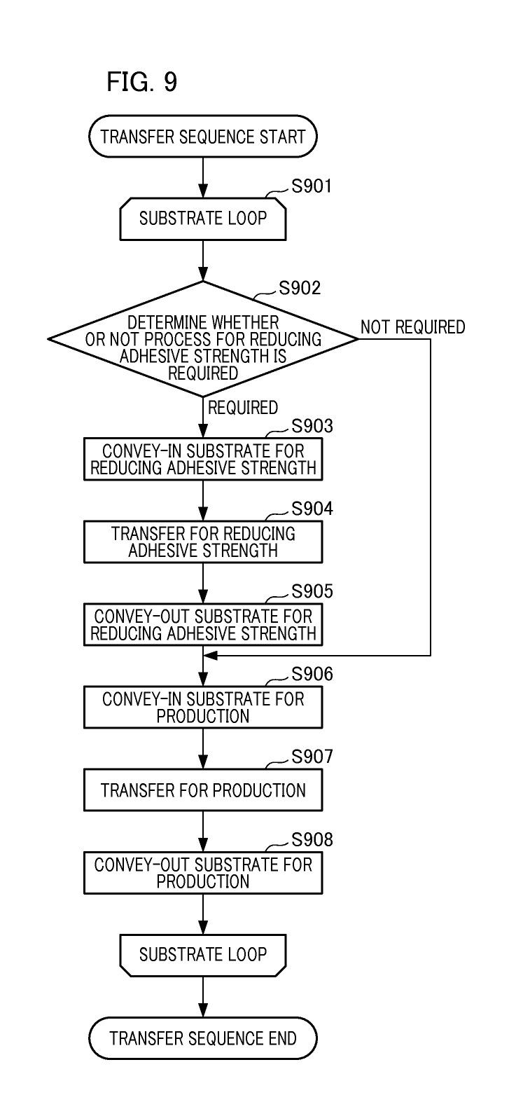

Here, a transfer sequence (imprint method) including a process for reducing adhesive strength according to the present embodiment will be described with reference to FIG. 9. In the transfer sequence according to the present embodiment, the imprint method as described with reference to FIGS. 2A to 2F is performed on the substrate 103 (substrate to be patterned) that has been conveyed to the substrate stage 104 for performing “transfer for production” (step S907). Every time the substrates 103 are conveyed, “substrate loop” (step S901) is performed for production. In the step S901, in order to determine whether or not “transfer for reducing adhesive strength” (step S904) is performed, “determination of necessity of process for reducing adhesive strength” (step S902) is performed. In the step S902, the upper limit of the number of times that the mask 102 is transferred to the substrate 103 in advance, and when the time exceeds the upper limit, it is determined that the step S904 is required. The criterion for the step S902 as described above is only one example and does not limit the use of other criteria. For example, the step S902 may use other criteria such as whether or not the total time of filling exceeds the predetermined time when the mask 102 is transferred to the substrate 103 or whether or not the number of the particle 401b observed by the filling camera 114 exceeds the predetermined number.

In the step S904, transfer conditions such as a number of transfer shot, a size of transfer shot, a filling time, an exposure time, or an applying pattern of the curable resin are specified independently of the conditions for the step S907. However, the transfer sequence is the same as the one for the step S907. Note that, when the substrate for reducing adhesive strength is spin-coated in advance with the photocurable resin 201 including the adjustment mixture containing an additive agent for reducing surface energy, the photocurable resin 201 is not applied by the applying mechanism 106. A number of transfer shots, a filling time, an exposure time, or an applying pattern of the curable resin are specified as the recipe for reducing adhesive strength.

When it is determined that the step S904 is required, “conveying-in substrate for reducing adhesive strength” (step S903) is performed. In the step S903, when the substrate for reducing adhesive strength is mounted on the substrate holding mechanism 108, it is conveyed-out to the substrate conveying-out exit 807, and while the substrate 103 (substrate to be patterned) is mounted thereon, it is conveyed-out to a substrate carrier 805 by the substrate conveyance unit 801. Next, the substrate for reducing adhesive strength that is held at the substrate conveying-in entrance 806 is conveyed into the substrate holding mechanism 108 by the substrate conveyance unit 801. After the substrate for reducing adhesive strength is obtained by the substrate conveyance unit 801 from the substrate conveying-in entrance 806, the apparatus reports to the substrate supply system 808 that the substrate conveying-in entrance 806 has become empty. After being reported, the substrate supply system 808 supplies the substrate for reducing adhesive strength to the substrate conveying-in entrance 806. In the step S904, the process is performed on one or more of shot region(s) in the substrate for reducing adhesive strength. The information about shot position(s) to be used for transfer is reported together with the information about the individual identification number of the substrate 103 from the substrate supply system 808. The information about the transfer area on which the step S904 has been performed is reported to the substrate supply system 808 together with the information about the individual identification number of the substrate 103. The information about the transfer area includes, for example, the shot center (X,Y) of each of the used shots 701 as well as the X size and Y size of the shot as shown in FIG. 7. After the step S904 has been performed, “conveying-out substrate for reducing adhesive strength” (step S905) is performed. In the step S905, the substrate conveyance unit 801 conveys-out the substrate to the substrate conveying-out exit 807. The apparatus reports to the substrate supply system 808 that the substrate 103 has been placed at the substrate conveying-out exit 807 after the substrate for reducing adhesive strength has been conveyed-out to the substrate conveying-out exit 807. After receiving such a notification, the substrate supply system 808 collects the substrates for reducing adhesive strength from the substrate conveying-out exit 807 to the substrate supply system 808. For example, when the unused region in the substrate for reducing adhesive strength is not enough, and the step S904 cannot be completed with one piece of substrate for reducing adhesive strength, another substrate for reducing adhesive strength can be continuously conveyed in order to solve this problem.

In the step S907, the process is performed under the condition(s) specified in the recipe for production by the imprint method as described with reference to FIGS. 2A to 2F. In “conveying-out substrate for production” (step S908), the substrate conveyance unit 801 conveys-out the substrate 103 in the substrate holding mechanism 108 to the substrate carrier 805.

As described above, the present embodiment provides the same effects as the first embodiment. Furthermore, in the present embodiment, even when the time from the process for spin-coating the substrate for reducing adhesive strength with a photocurable resin to the transfer process for reducing adhesive strength is limited for example, the releasability can be improved by the above-described substrate conveyance mechanism without reducing the productivity. Note that although the step S902 is performed every time after the step S908 in the transfer sequence, it may be performed in the step S907, in which the substrate for production is replaced with the transfer substrate for reducing adhesive strength once, and then the step S904 may be performed.

### Third Embodiment

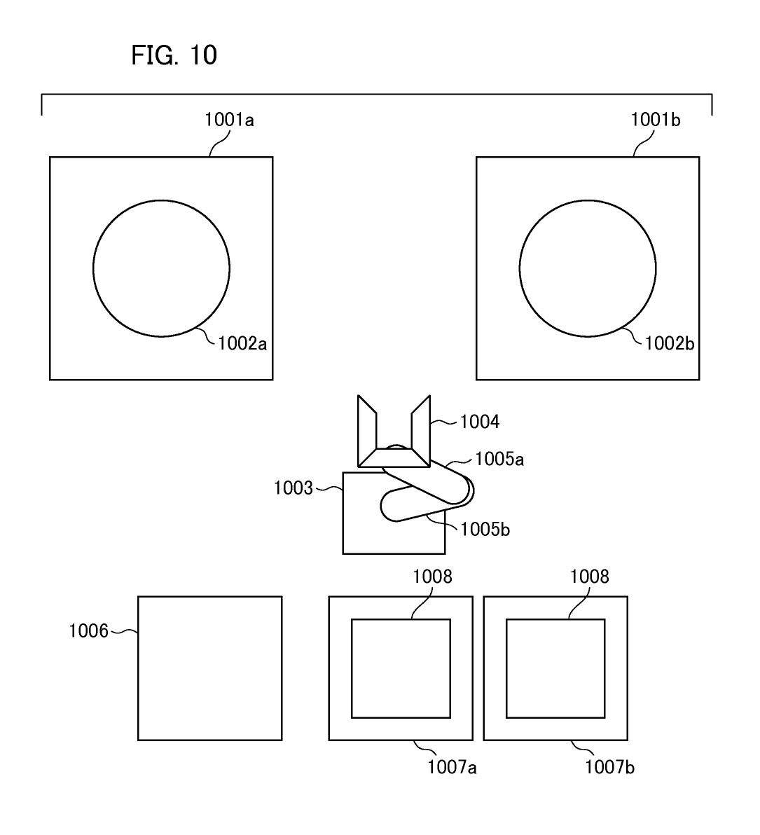

Next, an imprint method according to a third embodiment of the present invention will be described. The present embodiment includes two transfer systems (first and second transfer systems), and is different from the first and second embodiments in terms of how a substrate is conveyed. FIG. 10 is a schematic diagram illustrating a configuration of a substrate conveyance mechanism according to the present embodiment. Note that in the present embodiment, the same components as those in the first and second embodiments are designated by the same reference numerals and the detailed explanation thereof will be omitted. Additionally, since the configurations of the transfer system and transfer mechanism of the present embodiment are basically similar to those of the first embodiment, except for the parts regarding the substrate conveyance mechanism, the detailed explanation thereof will be omitted.

A substrate conveyance unit 1003 is composed of a first substrate conveyance arm 1005a and a second substrate conveyance arm 1005b that can be driven in the vertical direction, rotated and extended in the horizontal direction, and of a substrate conveyance hand 1004 that can be rotated in the horizontal direction. The substrate conveyance hand 1004, which includes a suction mechanism on the top surface, can suction the substrate 103. A substrate storage device 1006, which includes one or more slot(s), can store one or more substrate(s) 103. A substrate carrier 1008 that holds several pieces of substrate 103 is conveyed into/out of a first substrate conveying-in/out mechanism 1007a and a second substrate conveying-in/out mechanism 1007b. The substrate conveyance hand 1004 can convey-in/out the substrates 103 one by one to a first substrate stage 1001, a second substrate stage 1002, and any slot of the substrate storage device 1006. Furthermore, the substrate storage device 1006 can convey the substrates 103 one by one into/out of any slot of the substrate carrier 1008 attached to the first substrate conveying-in/out mechanism 1007a or the second substrate conveying-in/out mechanism 1007b. In the present embodiment, the substrate for reducing adhesive strength is stored in the substrate storage device 1006. Therefore, the substrate for reducing adhesive strength is conveyed through a path different from a conveyance path for the substrate for production (substrate to be patterned). Use of the same substrate for reducing adhesive strength for the first and second transfer systems allows more reduction in the number of the substrates for reducing adhesive strength that are stored in the substrate storage device 1006 compared with the case where their dedicated substrates for reducing adhesive strength are used for each of the first and second transfer systems.

In order to store the substrate for reducing adhesive strength in the substrate storage device 1006, the substrate carrier 1008 that holds the substrate for reducing adhesive strength is conveyed into the first substrate conveying-in/out mechanism 1007a or the second substrate conveying-in/out mechanism 1007b. Then, the substrate conveyance hand 1004 conveys the substrate for reducing adhesive strength into an empty slot of the substrate storage device 1006. When several pieces of substrate for reducing adhesive strength are stored in the substrate storage device 1006, the substrate conveyance hand 1004 conveys the substrates for reducing adhesive strength one by one into empty slots of the substrate storage device 1006 several times. When the used substrate for reducing adhesive strength is conveyed outside the apparatus, the substrate carrier 1008 having an empty slot is conveyed into the first substrate conveying-in/out mechanism 1007a or the second substrate conveying-in/out mechanism 1007b. Then, the substrate conveyance hand 1004 conveys-out the used substrate for reducing adhesive strength to an empty slot of the substrate carrier 1008. When several pieces of substrate for reducing adhesive strength are conveyed-out to the substrate carrier 1008, the substrate conveyance hand 1004 conveys the substrates for reducing adhesive strength one by one into empty slots of the substrate carrier 1008 several times.

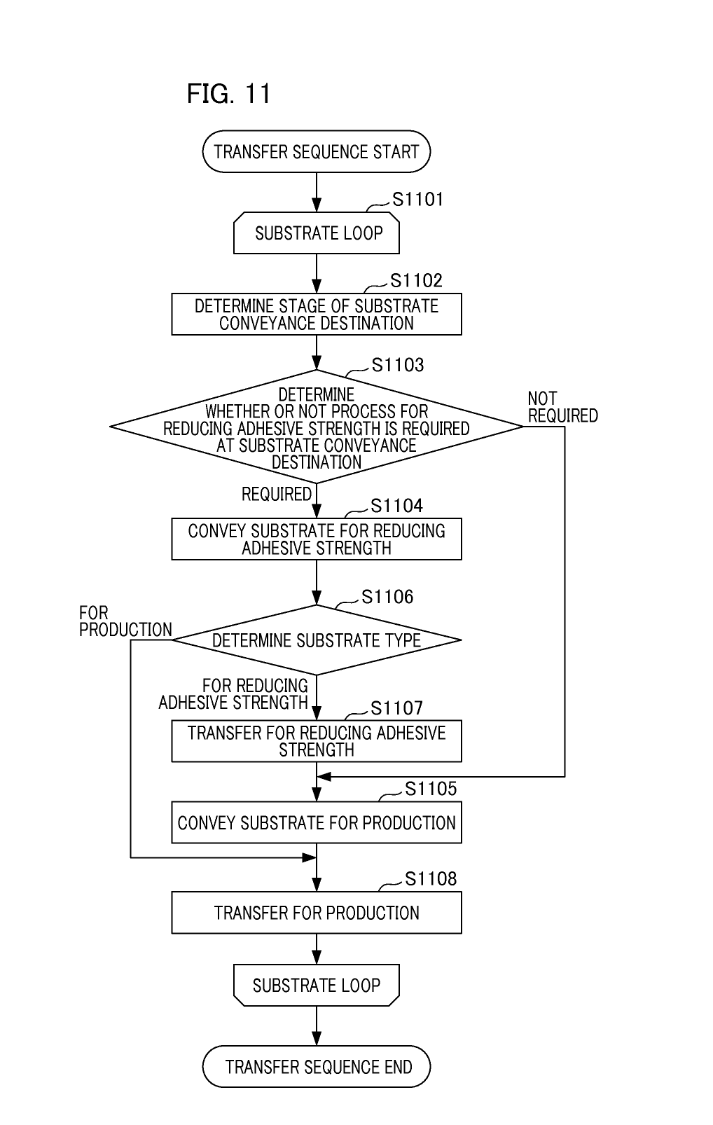

Here, a transfer sequence (imprint method) including a process for reducing adhesive strength according to the present embodiment will be described with reference to FIG. 11. In the transfer sequence, in “determination of stage of substrate conveyance destination” (step S1102), it is determined to which the substrate 103 (substrate to be patterned) is conveyed, the first substrate stage 1001 or the second substrate stage 1002. When “transfer for reducing adhesive strength” (step S1107) or “transfer for production” (step S1108) is being performed on the first substrate stage 1001 and the second substrate stage 1002, the substrate stage having less unprocessed shots is determined as the stage of substrate conveyance destination. When either the first substrate stage 1001 or the second substrate stage 1002 is in a standby state, the substrate stage that is in a standby state is determined as the stage of substrate conveyance destination. Both of the first substrate stage 1001 and the second substrate stage 1002 are in a standby state, the predetermined substrate stage out of the first substrate stage 1001 and the second substrate stage 1002 is determined as the stage of substrate conveyance destination.

In order to determine whether or not the step S1107 is performed in the transfer system to which the substrate has been conveyed, “determination of necessity of process for reducing adhesive strength at substrate conveyance destination” (step S1103) is performed. In the step S1103, the upper limit of the number of times that the mask 102 mounted on the first and second transfer systems is transferred to the substrate 103 (substrate to be patterned) is determined in advance, and when the time exceeds the upper limit, it is determined that the step S1107 is required. The criterion for the step S1103 described above is only one example and does not limit the use of other criteria. For example, the step S1103 may use other criteria such as whether or not the total time of filling when the mask 102 is transferred to the substrate 103 exceeds the predetermined time, or whether or not the number of the particles 401b observed by the filling camera 114 exceeds the predetermined number.

Here, one example will be taken and described below contemplating that the substrate 103 (substrate to be patterned) is conveyed into a first substrate holding mechanism 1002a and that the step S1107 is required. In “conveying-in substrate for reducing adhesive strength” (step S1104), when the substrate for reducing adhesive strength is not mounted on the first substrate holding mechanism 1002a, the substrate conveyance unit 1003 conveys-out the substrate to the substrate carrier 1008. Next, the substrate conveyance unit 1003 conveys the substrate for reducing adhesive strength that is stored in the substrate storage device 1006 into the first substrate holding mechanism 1002a. When a usable substrate for reducing adhesive strength is mounted on a second substrate holding mechanism 1002b, after the substrate for reducing adhesive strength has been used in the second transfer system, the substrate conveyance unit 1003 conveys it out to the second substrate holding mechanism 1002b. Then, it is conveyed into the first substrate holding mechanism 1002a. Here, when the substrate for reducing adhesive strength is conveyed out of the second substrate holding mechanism 1002b, the information about the transfer area as described below is updated based on the used result in the second transfer system. When the substrate for reducing adhesive strength is conveyed into the first substrate holding mechanism 1002a, the information about the individual identification number for identifying the type of the substrate is also reported to the first transfer system.

In the first transfer system, after the substrate has been conveyed into the first substrate holding mechanism 1002a, “determination of substrate type” (step S1106) is performed based on the information about the individual identification number. As a result of the step S1106, when it is determined to be the substrate for reducing adhesive strength, the step S1107 is performed, whereas, when it is determined to be the substrate for production, the step S1108 is performed. In the step S1107, transfer conditions such as a number of transfer shots, a size of a transfer shot, a filling time, an exposure time, or an applying pattern of the curable resin are specified independently of the conditions for the step S1108. However, the transfer sequence is the same as the one for the step S1108. A number of transfer shots, a filling time, an exposure time, or an applying pattern of the curable resin are specified as the recipe for reducing adhesive strength. After the step S1107 has been performed on one or more of shot region(s) in the substrate for reducing adhesive strength in this step, the substrate conveyance unit 1003 conveys-out the substrate for reducing adhesive strength to the substrate storage device 1006. The information about the transfer area on which the step S1107 has been performed is recorded for each substrate for reducing adhesive strength. The information about the transfer area includes, for example, the shot center (X,Y) of each of the used shots 701 as well as the X size and Y size of the shot as shown in FIG. 7. The information about the transfer area is maintained until the substrate for reducing adhesive strength has been conveyed outside the apparatus. Furthermore, the information about the transfer area is reported to the system external to the apparatus such that the system external to the apparatus can perform an replaced schedule of the substrates for reducing adhesive strength. The shot position(s) that can be used in the substrate for reducing adhesive strength is(are) determined from the used shots 701 in the information about the transfer area, the number of transfer shots specified in the recipe for reducing adhesive strength, and the X size and Y size of the transfer shot. Then, reserved shots 702 to be used in the step S1107 are determined. When there are several pieces of substrate for reducing adhesive strength having the reserved shots 702 of the number of the shots to be used in the step S1107 in the substrate storage device 1006 and the second substrate holding mechanism 1002b, the substrate for reducing adhesive strength in the substrate storage device 1006 is preferentially used. When there are several pieces of substrate for reducing adhesive strength in the substrate storage device 1006, the substrates for reducing adhesive strength are used preferentially in the older order conveyed to the substrate storage device 1006. The method for choosing the substrate 103 among a plurality of usable substrates for reducing adhesive strength as described above is only one example and does not limit the use of other criteria. For example, the substrate 103 in the upper slot of the substrate storage device 1006 may be preferentially used. Assume that there is no substrate for reducing adhesive strength having the reserved shots 702 of the number of shots to be used in the step S1107 in the substrate storage device 1006 and the second substrate holding mechanism 1002b. In this case, if the number of shots to be used in the step S1107 is satisfied by conveying several pieces of substrate stored in the substrate storage device 1006 and the second substrate holding mechanism 1002b, the substrates for reducing adhesive strength are conveyed one by one to the substrate holding mechanism 108, and then the step S1107 is performed. This is repeated until the required number of shots is satisfied. If the number of shots to be used in the step S1107 is not satisfied by conveying several pieces of substrate in the substrate storage device 1006 and the second substrate holding mechanism 1002b, the system external to the apparatus is requested to replace the substrates for substrates for reducing adhesive strength.

In “conveying substrate for production” (step S1105), the substrate conveyance unit 1003 conveyed-out the substrate 103 in the first substrate holding mechanism 1002a to a substrate storage device 1006 or the substrate carrier 1008. Next, the substrate conveyance unit 1003 conveys-in the substrate 103 in the substrate conveyance unit 1003 to the substrate holding mechanism 108. In the step S1108, the process is performed under the conditions specified in the recipe for production by the imprint method as described with reference to FIGS. 2A to 2F.

As described above, the present embodiment provides the same effects as the first and second embodiments. Furthermore, in the present embodiment, use of the imprint apparatus including more than one set of transfer mechanisms and substrate stages can improve the releasability without reducing the productivity. Note that, although the step S1103 is performed every time after the step S1105, it may be performed in the step S1108, in which the substrate for production is replaced with the transfer substrate for reducing adhesive strength once, and then the step S1107 may be performed.

### (Article Manufacturing Method)

A method for manufacturing a device (semiconductor integrated circuit element, liquid display element, or the like) as an article may include a step of forming a pattern on a substrate (wafer, glass plate, film-like substrate, or the like) using the imprint apparatus described above. Furthermore, the manufacturing method may include a step of etching the substrate on which a pattern has been formed. When other articles such as a patterned medium (storage medium), an optical element, or the like are manufactured, the manufacturing method may include another step of processing the substrate on which a pattern has been formed instead of the etching step. The device manufacturing method of the present embodiment has an advantage, as compared with a conventional method, in at least one of performance, quality, productivity and production cost of an article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-148752 filed Jul. 22, 2014, which is hereby incorporated by reference herein in its entirety.

What is claimed is:

1. An imprint method for performing an imprint process in which an imprint material on a substrate to be patterned is brought into contact with a pattern of a mold to form a pattern of the imprint material, the imprint method comprising a step of determining whether or not a process for reducing adhesive strength between the imprint material and the pattern of the mold is required,
wherein, if the determination step determines that the process for reducing adhesive strength is required, the process for reducing adhesive strength is performed by bringing a material for reducing adhesive strength on a substrate for reducing adhesive strength, which is different from the substrate to be patterned, into contact with the pattern of the mold, and then the imprint process is performed, and
wherein if the determination step determines that the process for reducing adhesive strength is not required, the process for reducing adhesive strength is not performed and the imprint process is performed.

2. The imprint method according to claim 1, wherein the determination step determines that the process for reducing adhesive strength is required if the number of transfer of the pattern of the mold to the imprint material on the substrate to be patterned exceeds a predetermined number.

3. The imprint method according to claim 1, wherein in a case where transfer of the pattern of the mold to the imprint material on the substrate to be patterned is performed several times, the determination step determines that the process for reducing adhesive strength is required if a total time of filling of the imprint material into the pattern of the mold exceeds a predetermined time.

4. The imprint method according to claim 1, wherein the determination step determines that the process for reducing adhesive strength is required if a number of contaminated particles between the substrate to be patterned and the mold exceeds a predetermined number.

5. The imprint method according to claim 1, wherein the substrate for reducing adhesive strength is conveyed out of a substrate storage device that is different from a storage device where the substrate to be patterned is stored.

6. The imprint method according to claim 1, wherein the substrate for reducing adhesive strength is conveyed through a path that is different from a conveyance path for the substrate to be patterned by a substrate conveyance mechanism.

7. An imprint apparatus for performing an imprint process in which an imprint material on a substrate to be patterned is brought into contact with a pattern of a mold to form a pattern of the imprint material, the imprint apparatus comprising a control unit configured to control the imprint process,
wherein the control unit is configured to determine whether or not a process for reducing adhesive strength is required in order to reduce the adhesive strength between the imprint material and the pattern of the mold,
wherein, if the control unit is configured to determine that the process for reducing adhesive strength is required, the control unit is configured to control the apparatus to perform the process for reducing adhesive strength by bringing a material for reducing adhesive strength on the substrate for reducing adhesive strength, which is different from the substrate to be patterned, into contact with the pattern of the mold, and then to perform the imprint process, and
wherein, if the control unit is configured to determine that the process for reducing adhesive strength is not required, the control unit is configured to control the apparatus not to perform the process for reducing adhesive strength, and to perform the imprint process.

8. A method for manufacturing an article, the method comprising steps of:
patterning an imprint material on a substrate by an imprint method for performing an imprint process in which the imprint material on the substrate to be patterned is brought into contact with a pattern of a mold, and processing the patterned substrate,
wherein the imprint method includes a step of determining whether a process for reducing adhesive strength between the imprint material and the pattern of the mold is required or not,
wherein, if the determination step determines that the process for reducing adhesive strength is required, the process for reducing adhesive strength is performed by bringing a material for reducing adhesive strength on a substrate for reducing adhesive strength, which is different from the substrate to be patterned, into contact with the pattern of the mold, and then the imprint process is performed, and
wherein, if the determination step determines that the process for reducing adhesive strength is not required, the process for reducing adhesive strength is not performed and the imprint process is performed.
